(19) United States
(12) Patent Application Publication
(10) Pub. No.: US 2019/0373848 A1
(43) Pub. Date: Dec. 12, 2019

(54) PET BARRIER

(71) Applicant: MICHAEL D. MLOSTEK, BAY CITY, MI (US)

(72) Inventor: MICHAEL D. MLOSTEK, BAY CITY, MI (US)

(21) Appl. No.: 16/004,611

(22) Filed: Jun. 11, 2018

(51) Int. Cl. A01K 1/035; A01M 29/30

(52) U.S. Cl. CPC A01K 1/035; A47C 31/11; A01M 29/30

(57) ABSTRACT

A pet barrier is disclosed. When the pet barrier is deployed the second flat panel slides under the cushion of a piece of furniture and is slid toward the back of the furniture until it fits snuggly against the cushion and projects the first panel of the pet barrier upward blocking access to the furniture.

### BACKGROUND OF THE INVENTION

The applicant is aware of the following prior art. U.S. Pat. No. 6,367,423, entitled, “Device For Protecting Furniture From Pet Damage”, issued to Sheuer, on Apr. 9, 2002. The Scheuer patent discloses a device for protecting furniture from pet damage for preventing pets from chewing on covered areas of the furniture covered by panels of the invention.

In U.S. Pat. No. 5,702,791, entitled, “Furniture Protector Device” issued to Zegeer, on Dec. 30, 1997. The Zegeer patent discloses a furniture protector for protecting the fabric of upholstered furniture such as sofas and easy arm chairs and the like.

In U.S. Pat. No. 6,749,922, entitled, “Furniture Protection System”, issued to Waselewski, on Jun. 15, 2004 discloses a furniture protection device n a generally rectangular configuration that is comprised of a flat piece. The flat piece has a pair of long parallel side edges. The flat piece also has a pair of short parallel side edges. The flat piece further has a plurality of equally spaced creases. The equally spaced creases run parallel to the short side edges.

In U.S. Pat. No. 8,245,668, entitled, “Furniture Pet Deterrent Apparatus”, issued to Alberti, on Aug. 21, 2012 discloses an apparatus to deter pets from lying on a seat portion which extends between opposite arms each on an end of a piece of furniture.

### THE INVENTION

The present invention is a device to prevent animals from jumping onto cushioned furniture. The device comprises a first flat panel that has a first edge and a second edge and a second flat panel that has a first edge and a second edge. The first flat panel and the second flat panel are attached to each other at the first edges by a common hinge. The first flat panel second edge and the second flat panel second edge each have an attachment device located near a center point thereof.

There is also a tether. This tether has two ends. Each of the ends is attached to the attachment device.

### BRIEF DESCRIPTION OF THE DRAWINGS

FIG. 1 illustrates the pet barrier deployed on a piece of furniture.

FIG. 2 shows the pet barrier fully open.

FIG. 3 shows the pet barrier opened to be deployed into a piece of furniture.

FIG. 4 shows the pet barrier collapsed to be stored.

### DETAILED DESCRIPTION OF THE DRAWINGS

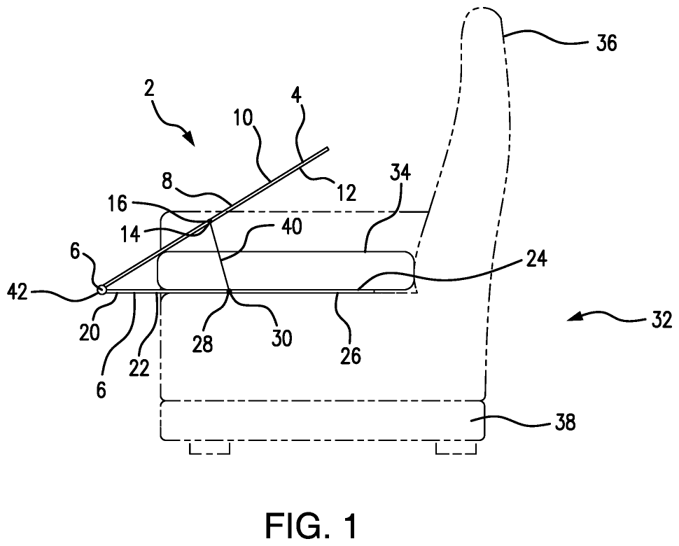

FIG. 1 shows the pet barrier 2 deployed on a piece of furniture 32. The pet barrier has a first flat panel 4 that is joined to a second flat panel 18. The first flat panel 4 and the second flat panel are joined by a common hinge 42. The first flat panel 4 has a first edge 6. The first edge 6 shows the attachment of the hinge 42. The second flat panel 18 has a first edge 20. This first edge 20 is where the hinge 42 is attached.

The first flat panel 4 has a second edge 8. The second edge 8 has a center point 10 and is near where the attachment device 14 of the first flat panel 4 is located. The first flat panel 4 has a top surface 10 and a bottom surface 12.

The second flat panel 18 has a second edge 22. The second edge 20 has a center point 30 and is near where the attachment device 28 of the second flat panel 18 is located. The second flat panel 18 has a top surface 24 and a bottom surface 26. The attachment device 14 of the first flat panel 4 and the attachment point 28 of the second flat panel 18 are connected by the tether 40.

The furniture 32 has a cushion 34, back 36 and a bottom 38. When the pet barrier 2 is deployed, the second flat panel 18 slides under the cushion 34 and is slid toward the back 36 of the furniture until it fits snuggly against the cushion 34 projecting the first panel 4 of the pet barrier upward. With the first panel 4 deployed in an upward position it prevents pets from being able to jump upon and lay on the furniture 32. When the user wishes to use the furniture they simply remove the pet barrier, collapse it, and place it under the furniture 32 until it is needed again.

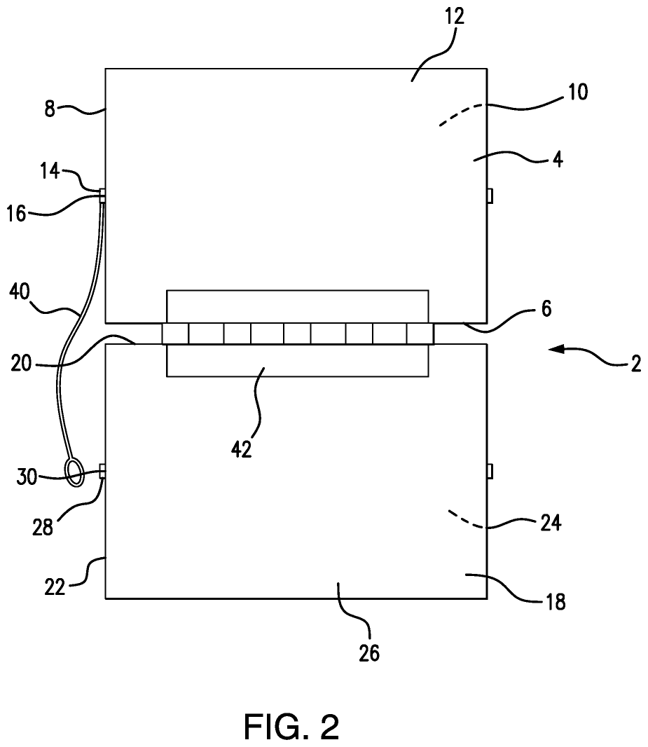

FIG. 2 shows the pet barrier 2 fully open. This shows the bottom 12 of the first flat panel 4. Also shown is the bottom 26 of the second flat panel 18. The first edge 6 of the first flat panel 4 is joined to the first edge 20 of the second panel 18 by a hinge 42.

The second edge 8 of the first flat panel 4 has a center point 16. Near the center point 16 is the attachment device 14. One end of the tether 40 is attached to the attachment device 14. The second edge 22 of the second flat panel 18 has a center point 30. Near the center point 30 is the attachment device 28. When the pet barrier is deployed one end of the tether 40 is attached to the attachment device 28.

The hinge 42 is attached to the first edge 6 of the first flat panel 4 and the first edge 20 of the second flat panel 18 on the bottom of the first flat panel 12 and the bottom 26 of the second flat panel 18.

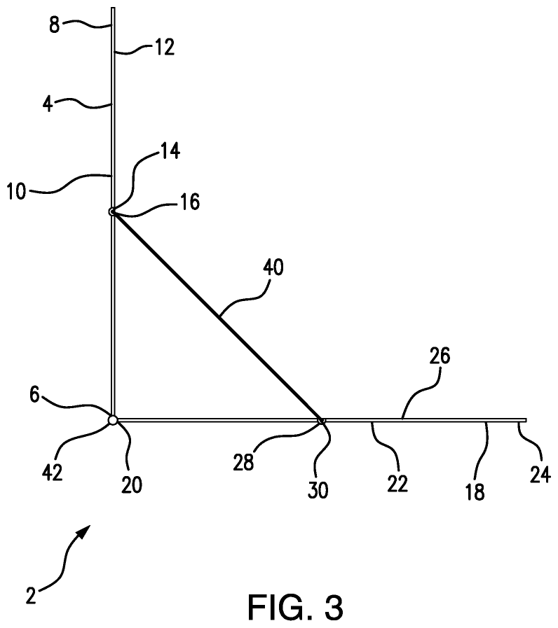

FIG. 3 shows the pet barrier 2 opened to be deployed into a piece of furniture 32. The second flat panel 18 is slid under a cushion 34 with its bottom surface 26 against the cushion 32 and the top surface 24 toward the bottom 38 of the furniture 32.

With the second flat panel 18 secured under the cushion 34 the first flat panel 4 leans against the cushion 34 angling toward the back 36 of the furniture 32. It has been discovered that the tether 42 keeps the first and second panels 4 and 18 in place while the pet barrier 2 is in the deployed position preventing the pet from accessing the furniture 32.

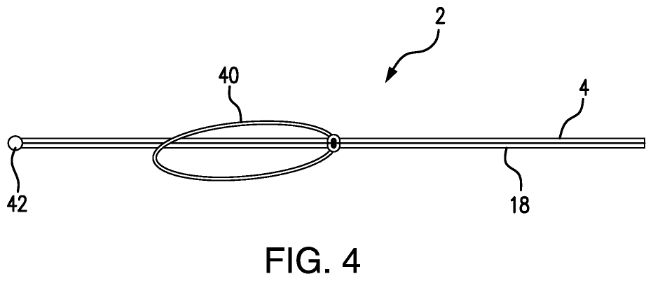

FIG. 4 shows the pet barrier 2 collapsed to be stored. With the first flat panel 4 collapsed against the second flat panel 18 of the pet barrier 2 it conveniently slides under the piece of furniture that it is being used to protect.

In one embodiment the hinge of the device is a friction hinge. In another embodiment the flat panels are at least two feet by 2 feet in size. In another embodiment the flat panels are at least 3/16 inches thick.

In another embodiment the flat panels are manufactured from plastic. In another embodiment the flat panels are manufactured from cardboard. In another embodiment the flat panels are manufactured from rubber. In another embodiment the flat panels are manufactured from metal. In another embodiment the metal is aluminum.

What is claimed is:

1. A device to prevent animals from jumping onto cushioned furniture, said device comprising:
a. a first flat panel having a first edge and a second edge;
b. a second flat panel having a first edge and a second edge,
c. said first flat panel and said second flat panel being attached to each other at said first edges by at least one common hinge;
said first flat panel second edge and said second flat panel second edge each having an attachment device located near a center point thereof;

2. The device as claimed in claim 1 wherein, in addition, there is a tether, said tether having two ends, each of said ends being attached to a said attachment device.

3. A device as claimed in claim 1 wherein the hinge is a friction hinge.

4. A device as claimed in claim 1 wherein the flat panels are at least two feet by 2 feet in size.

5. A device as claimed in claim 1 wherein the flat panels are at least 3/16 inches thick.

6. A device as claimed in claim 1 wherein the flat panels are manufactured from plastic.

7. A device as claimed in claim 1 wherein the flat panels are manufactured from cardboard.

8. A device as claimed in claim 1 wherein the flat panels are manufactured from rubber.

9. A device as claimed in claim 1 wherein the flat panels are manufactured from metal.

10. A device as claimed in claim 9 wherein the metal is aluminum.

11. A device as claimed in claim 1 wherein there are two hinges.
